(19) United States
(12) Patent Application Publication
(10) Pub. No.: US 2004/0099586 A1
(43) Pub. Date: May 27, 2004

(54) Catch basin attachment

(76) Inventor: Muneisa Imoto, Higashiosak-shi (JP)

Correspondence Address: Rader Fishman & Grauer, Suite 501, 1233 20th Street N W, Washington, DC, 20036, US

(21) Appl. No.: 10/474,362

(22) PCT Filed: Mar. 4, 2002
(86) PCT No.: PCT/JP02/01976

(30) Foreign Application Priority Data
Apr. 16, 2001 (JP) 2001-116518

(51) Int. Cl. B01D 35/14

(52) U.S. Cl. 210/85; 210/163; 210/97

(57) ABSTRACT

The object of the present invention is to provide a drainage basin attachment which can prevent breeding of mosquitoes in a puddle inside the drainage basin and also can shield scattering of an odor from the inside. The attachment includes a supporting member retained to the upper end of the basin body and an inner gate supported by the supporting member beneath the basin lid to close the top opening of the basin body. The inner gate forms an inner basin for temporarily storing the rainwater passing through the basin lid. The inner gate is normally closed and is opened by an action of force acting on the inner gate by the rainwater accumulated in the inner basin to an extent above a predetermined level, thereby dropping the rainwater from the inner basin into the basin body.

### TECHNICAL FIELD

The present invention relates to a drainage basin attachment for a drainage basin installed in a gutter of a road, a homesite, etc., and, more particularly, to a drainage basin attachment which can prevent breeding of mosquitoes in a puddle inside the drainage basin, and also, can shield scattering of an odor from the inside.

### BACKGROUND ART

In a conventional drainage basin which is installed midway through a drainage channel and introduces water into the inside of the drainage basin from drain holes formed in a basin lid, since the drainage channel is connected to a basin body in a little upper position from a bottom of the drainage basin, a puddle is inevitably left in the bottom. Since the puddle is made in the bottom of the drainage basin as mentioned above, mosquitoes will encroach easily from the drain holes in the basin lid and lay eggs in the puddle. Accordingly, mosquito larvae will hatch and become mosquitoes, and the mosquitoes will fly in all directions from the drain holes. In this way, the drainage basin in roads, factories, homes, etc. is a hotbed of mosquitoes. Also, a filthy odor from the puddle in the drainage basin will diffuse to the outside.

By the way, as a means to prevent encroaching of mosquitoes, a construction which attaches a net so that the drain holes can be covered in the rear face of the basin lid has been proposed. But, in such a construction, since the net is attached to the bottom of the drain holes, there is a problem that refuse may be accumulated on the net and then may block the drain holes. Also, such a construction can not solve the problem that the odor leaks from the drain holes.

Incidentally, the eggs of the mosquitoes, produced in water, will pass a dryness state, where water was lost in the puddle, in an egg stage, and they wait for an opportunity where water is accumulated by next rainfall and thereat they metamorphose into mosquito larvae. In this way, mosquitoes are generated.

### DISCLOSURE OF THE INVENTION

In view of the above problem, the object of the present invention is to provide a drainage basin attachment which can prevent breeding of mosquitoes in a puddle inside the drainage basin installed in a gutter of a road, a homesite, etc., and also, can shield scattering of an odor from the inside.

A drainage basin attachment of the present invention is adapted to be installed in a drainage basin A composed of a basin body 14 installed midway through a drainage channel, and a basin lid 1 closing a top opening of the basin body and having a number of drain holes 2 for passing rainwater therethrough. The attachment includes a supporting member 20 retained to the upper end of the basin body and an inner gate 3 supported by the supporting member 20 beneath the basin lid 1 to close the top opening of the basin body. The inner gate 3 forms an inner basin B for temporarily storing the rainwater passing through the basin lid 1. The inner gate 3 is normally closed and is opened by an action of force acting on the inner gate 3 by the rainwater accumulated in the inner basin B to an extent above a predetermined level, thereby dropping the rainwater from the inner basin B into the basin body 14. Therefore, the rainwater coming into the inside from the drain holes 2 of the basin lid 1 is stemmed by the inner gate 3 of a closing position, and the rainwater can be released into the basin body 14 by opening the inner gate 3 when the stemmed rainwater exceeds a predetermined amount. In this way, drainage of the rainwater can be made without any problem. Since the inner gate 3 is closed while it is not raining, this attachment can prevent mosquitoes which encroached from the drain holes 2 of a basin lid 1 from laying eggs in a puddle. Therefore, the attachment can prevent the breeding of mosquitoes in the drainage basin certainly, and also can prevent leaking of a filthy odor.

In a preferred embodiment of the present invention, the inner gate 3 comprises a pair of slanted plates 6. Each plate is supported pivotally at its upper end to the supporting member 20 to be pivotable about a horizontal pivot axis. Each of the slanted plates 6 is biased by a closing means 4 into a closed position where the slanted plates abut at their lower ends to form the inner basin B of a V-shaped section. That is, the inner gate 3 is constituted as a double hinged door, and can easily drain away the rainwater accumulated in the V-shaped inner basin. Thus, a drainage function of the inner gate 3 is good.

In another preferred embodiment of the present invention, the inner gate 3 comprises a fixed plate 8 fixed to the supporting member 20 and depending therefrom into the basin body 14 and a slanted plate 9 which extends from the supporting means 20 in an opposed relation to the fixed plate to form therebetween the inner basin B. The slanted plate 9 is pivotally supported at its upper end to the supporting member to be pivotable about a horizontal pivot axis. The inner gate 3 also has a closing means 4 which biases the slanted plate 9 into a closed position where the slanted plate 9 abut at its lower end with the lower end of the fixed plate 8 to close the inner basin. That is, the inner basin is constituted as a single hinged door, which is simple structure with few movable parts.

It is preferable that the above closing means 4 comprises a balancer weight 10 connected to the slanted plate 8, 9 on opposite of the horizontal pivot axis from the slanted plate. In this case, as compared with a case where a spring is used as the closing means, a mechanism that opens and closes the inner gate can be simplified and has high durability, and opening-and-closing performance can be stabilized for long periods. So, such mechanism is effective in the installation site where generating of bad smells, such as methane, should be prevented.

Furthermore, it is preferable that the supporting member 20 has a flange 5 which is held between the basin lid 1 and a shoulder 17 formed around the top opening of the basin body to support thereon the basin lid. In this case, it is easy to install the drainage basin attachment in an existing drainage basin A.

Still furthermore, it is preferable that the inner gate 3 includes a flap valve 12 which permits a reverse water flow from the basin body 14 into the inner basin B. This makes it possible for the rainwater accumulated in the drainage basin A to open the flap valve 12 and overflow into a road while, for example, concentrated heavy rain.

It is preferable to use a means which opens the inner gate 3 in response to an output of a rain sensor 29 instead of the spring or the balancer weight. The rain sensor 29 senses amount of rainfall accumulated in the inner basin B, and provides the output when sensing a critical amount of rainfall. The means for opening the inner gate opens the inner gate 3 in response to the output, and except above, the means keeps the inner gate 3 closed. This makes it possible to carry out a opening-and-closing control of the inner gate certainly, and prevent the breeding of mosquitoes in the drainage basin certainly.

### BRIEF DESCRIPTION OF THE DRAWINGS

FIG. 1 is a schematic sectional view showing an installation condition of a drainage basin attachment in accordance with a first embodiment of the present invention.

FIG. 2 is a plan view of the drainage basin attachment of FIG. 1.

FIG. 3 is a perspective view of a drainage basin attachment looking from above in accordance with a second embodiment of the present invention.

FIG. 4 is a perspective view of the drainage basin attachment of FIG. 3 looking from below.

FIG. 5 is a schematic sectional view showing an installation condition of the drainage basin attachment of FIG. 4.

FIG. 6 is a explanatory view showing movement of a flap valve provided in the drainage basin attachment of FIG. 5.

FIG. 7 is a perspective view of the drainage basin attachment of FIG. 6 looking from below.

FIG. 8 is a schematic sectional view showing an installation condition of a drainage basin attachment in accordance with a third embodiment of the present invention.

FIG. 9 is a perspective view of the drainage basin attachment of FIG. 8 looking from below.

FIG. 10 is a perspective view showing movement of a flap valve provided in the drainage basin attachment of FIG. 9.

FIG. 11A is a perspective view of a drainage basin attachment in accordance with a fourth embodiment of the present invention.

FIG. 11B is a enlarged perspective view of a portion of the drainage basin of FIG. 11A.

FIG. 12A is a schematic sectional view showing an installation condition of a drainage basin attachment in accordance with a fifth embodiment of the present invention.

FIG. 12B is a block diagram showing an opening-and-closing mechanism used for the drainage basin attachment of the FIG. 12A.

### BEST MODE FOR CARRING OUT THE INVENTION

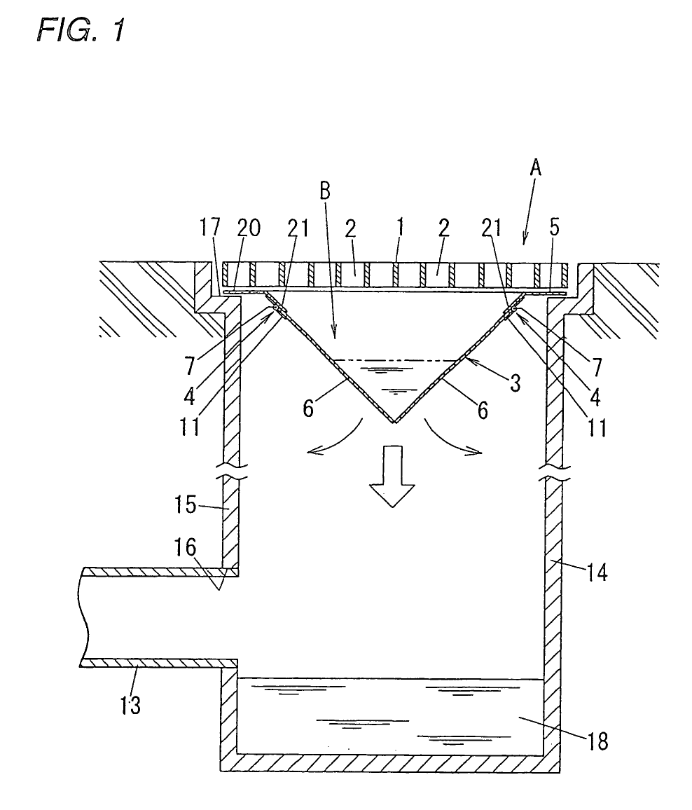

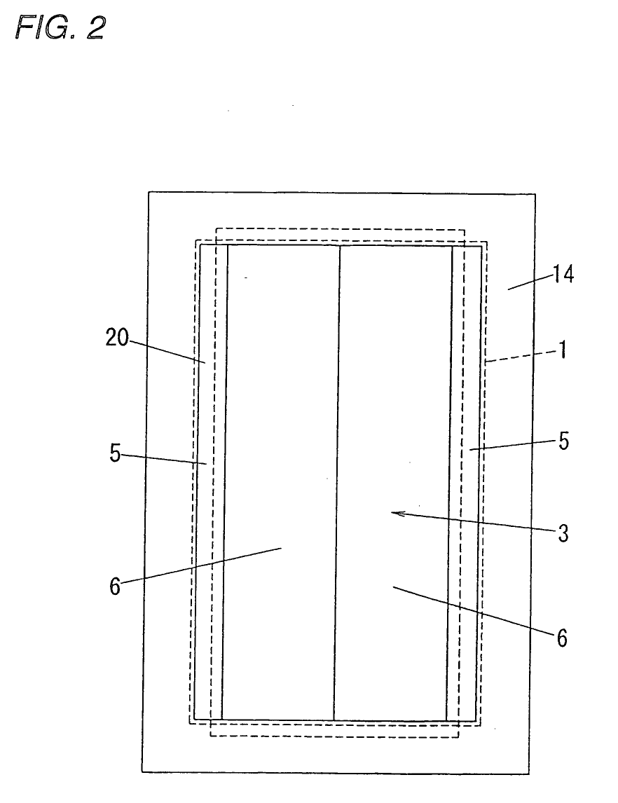

Hereinafter, an embodiment of the present invention will be described. FIG. 1 is a schematic sectional view showing an installation condition of a drainage basin attachment in accordance with a first embodiment of the present invention. FIG. 2 is a plan view of the attachment. The drainage basin attachment of the present invention is applied to a drainage basin A which is installed in order to connect to drainage channels such as, for example, gutters along a side of a road, drains like culverts, and drainage pipes 13 laid underground of sites of homes or factories. The drainage basin A has a basin body 14, which is made of, for example, cement and has a bottom. The drainage basin also has plural connection holes 16 in side walls 15, and the drainage pipes 13 are connected to the connection holes 16. A shoulder 17 is formed around the top opening of the basin body 14. A basin lid 1 lies on the shoulder 17. The basin lid has a number of drain holes 2 which serve to introduce rainwater into the inside of the basin body and drain away the water. The drainage pipes 13 are connected to a basin body 14 in a little upper position from the bottom of the basin body in order to form a storage part 18 in the bottom. The storage part 18 collects soil, pebbles, etc. which fell in the drainage basin A, and prevents them from flowing into the drainage pipes 13.

The attachment comprises a supporting member 20 and a inner gate 3 supported by the supporting member 20. The supporting member 20 is a shape of rectangle frame and is retained to the upper end of the basin body beneath the basin lid 1. The inner gate 3 comprises a pair of slanted plates 6, which are pivotally supported at its upper end to a flange 5, a periphery part of the supporting member 20, by a horizontal pivot axis 7 such as a pin to be pivotable about the horizontal pivot axis 7, respectively. Each slanted plate 6 is biased upward by, for example, a coil spring 11, thereby reaches a pivot upper limit position where each slanted plate touches a pivot regulation board 21 extending from the supporting member 20. At that time, the slanted plates abut at their lower ends and keep a closed position where a inner basin B is formed under the basin lid 1. The both sides of the inner basin B are closed by the side walls of the basin body 14. Alternatively, the both sides of the inner basin B may be closed by side plates depending from the supporting member 20. The inner gate 3 is made of, for example, a coated iron plate, a stainless plate, aluminum, synthetic resin, or FRP, etc. Instead of the coil spring 11, a leaf spring may bias the slanted plate 6.

As stated above, in the present invention, the inner gate 3 is provided inside the drainage basin A in the closed position where rainwater is stemmed, and the inner gate is opened by gravitation which exceeds a predetermined level. Therefore, the rainwater coming into the inside from the drain holes 2 of the basin lid 1 is accumulated in the inner basin B formed by the inner gate 3 of the closed position, and when the stemmed rainwater exceeds a predetermined amount and the gravitation exceeds the predetermined level, the rainwater turns the slanted plate 6 against the spring force and opens the inner gate 3, thereby the rainwater is drained away into the bottom of the basin body 14. When there is no rainfall, the inner gate 3 is kept in the closed position. So, even if a mosquito encroaches from the drain holes 2 of the basin lid 1, it can not arrive at the puddle of the bottom of the basin body 14 and can not lay eggs in the puddle. Accordingly, this invention can prevent the breeding of mosquitoes in the drainage basin A certainly. Also, this invention can prevent leaking of a filthy odor.

In this embodiment, the inner gate 3 forms a double hinged door in which the pair of slanted plates 6 abuts at their lower ends to form the closed position of a V-shaped section, which makes it possible for the pair of slanted plates 6 to be opened smoothly by gravitation of the rainwater accumulated in the V-shaped valley. In other words, because the inner gate 3 is the double hinged door and the force acting by the amount of the rainwater for opening the inner gate 3 is equally shared with each slanted plate 6, the force to open each slanted plate 6 can be made small (½), as compared with a case where only one slanted plate is opened, thereby opening responsibility of the inner gate 3 can be improved. In addition, a net may be provided above the inner gate 3 and under the basin lid 1 to receive foreign substances such as dust and refuse and prevent such foreign substances from coming into the inside of the drainage basin A.

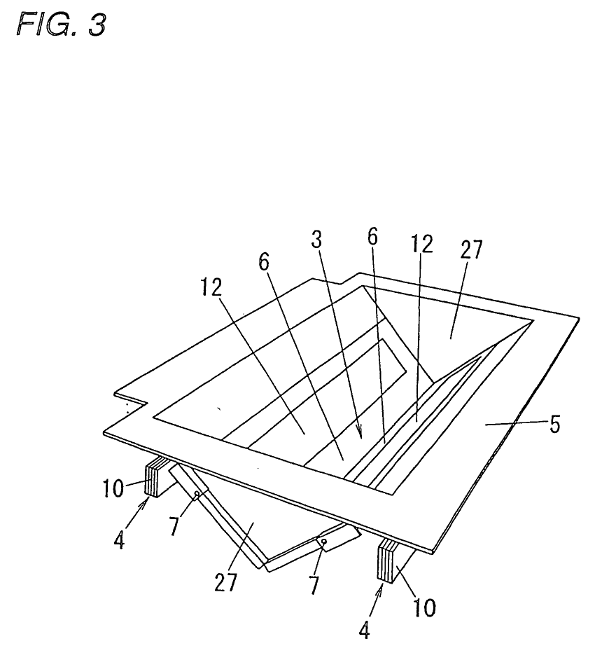

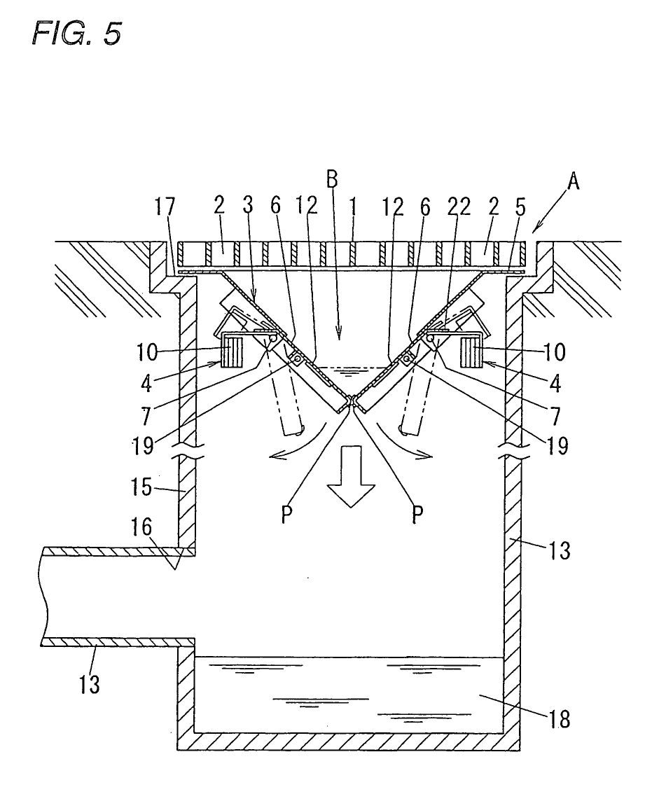

FIGS. 3-7 shows a second embodiment of the present invention. The basic composition of this embodiment is identical to the first embodiment, so the similar part of these embodiments are identified by the same reference character and no duplicate explanation are made here. In this embodiment, side plates 27 of a generally triangle shape are fixed in the supporting member 20, and the slanted plates 6 are pivotally fitted to the side plates 27 through attachment pieces 33 by a horizontal pivot axis 7 such as a pin, thereby the slanted plates 6 can pivot around the horizontal pivot axis 7, respectively. In this case, a closing means 4 to close the slanted plates 6 is constructed by balance weights 10 which are installed through stays 32 in extended pieces 22 which is extending over the supporting point from the slanted plates 6. As compared with the construction in which the slanted plates are closed by the spring, the construction in which the balance weights 10 are adopted as the closing means 4 can increase endurance to close the slanted plates 6 greatly and can keep the inner gate 3 stably in the closed position over long periods. Such construction is suitable to a drainage basin A which have a possibility that bad smells, such as methane, may leak. In this embodiment, packing P is attached to the lower ends of each slanted plate 6 to close the inner gate 3 with airtightness improved.

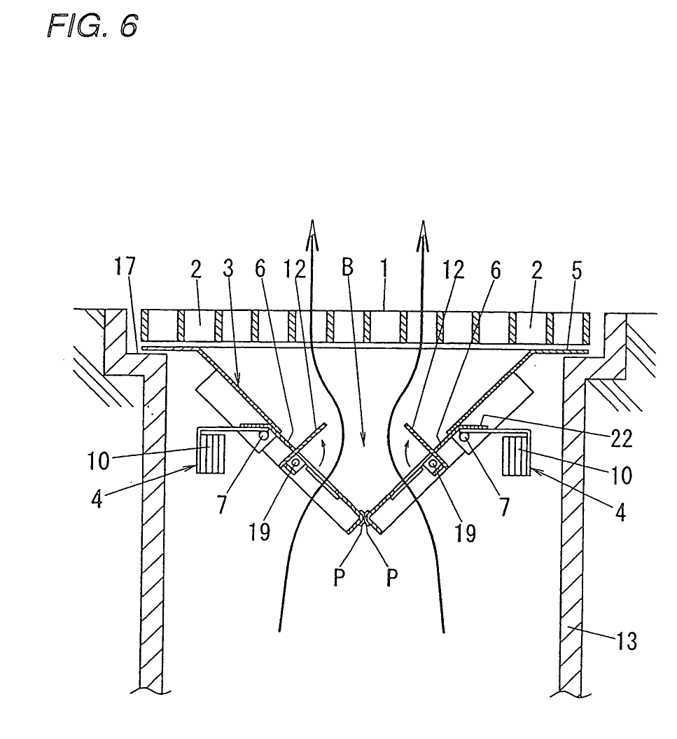

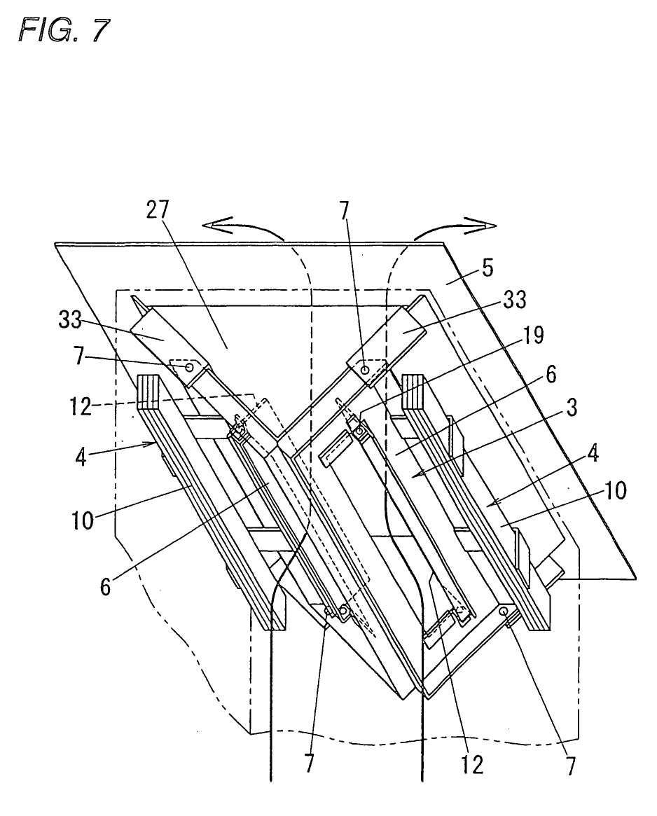

Furthermore, the inner gate 3 includes flap valves 12 which can be opened by swollen water inside the drainage basin and permits a reversed water flow. The flap valves 12 are supported respectively to each slanted plate 6 to be pivotable about a horizontal pivot axis 19 such as pins. Thus, as shown in FIGS. 6 and 7, since the swollen water inside the drainage basin A can open the flap valves 12 and overflow into a road even if it is, for example, in the concentrated heavy rain, there is no problem with the inner gate 3 which is normally closed.

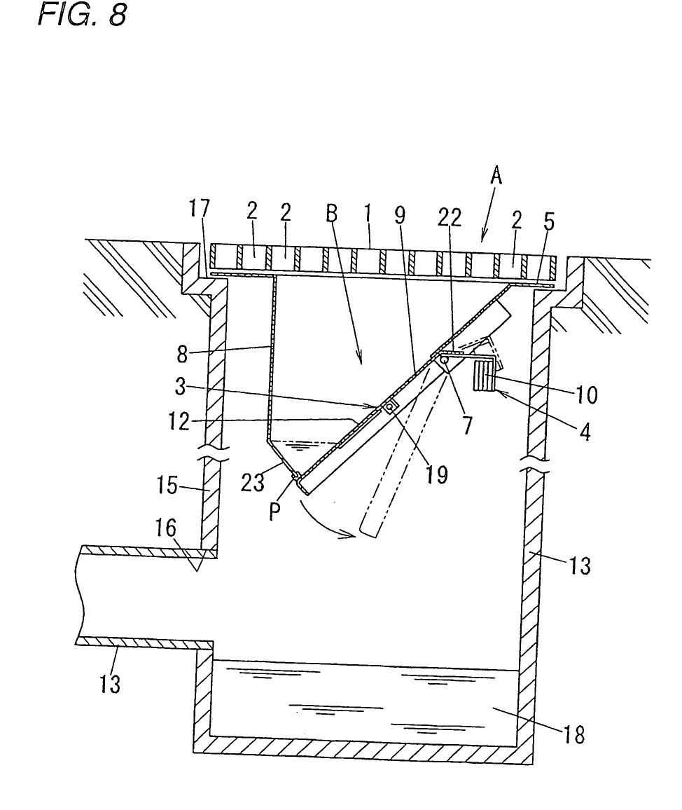

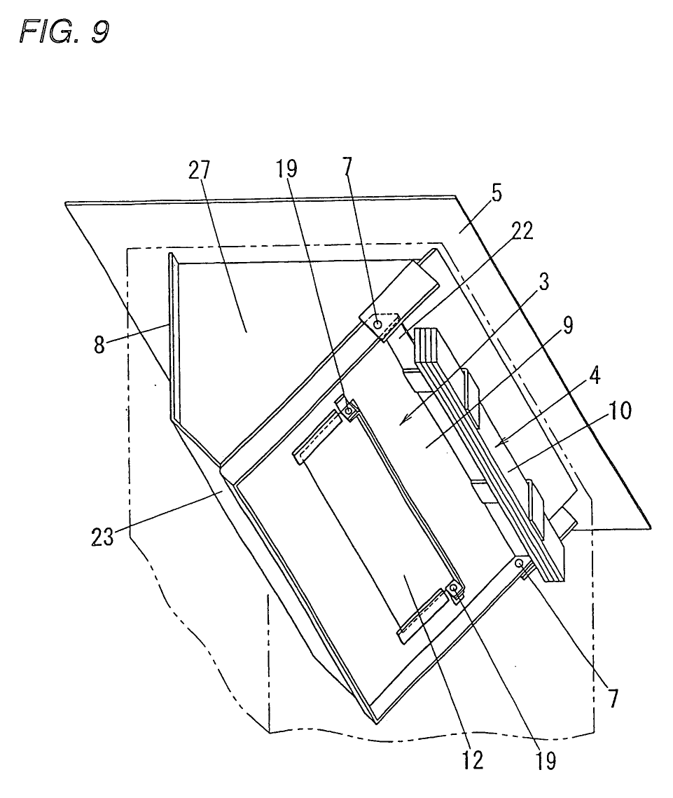

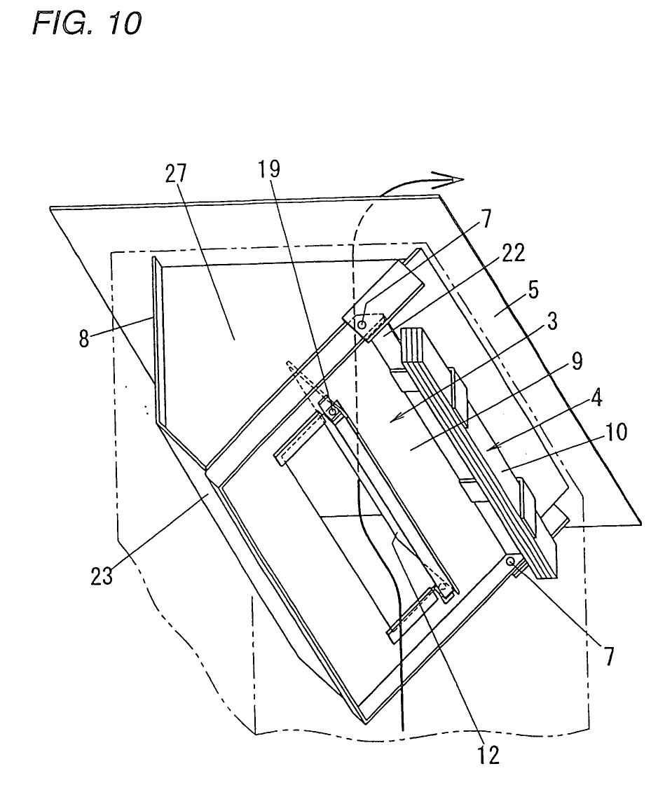

FIGS. 8 and 9 shows a third embodiment of the present invention. The basic composition of this embodiment is identical to the above embodiment, so the similar part of these embodiments are identified by the same reference character and no duplicate explanation are made here. In this embodiment, the inner gate 3 has a fixed plate 8 depending from the supporting member and a slanted plate 9 which touches the lower end of the fixed plate 8. The slanted plate 9 is pivotally supported at its upper end by the horizontal pivot axis 7 and is biased by the balance weights 10 as the closing means 4 into a closed position where the slanted plate 9 abut at its lower end with a piece 23 extending slantingly from the lower end of the fixed plate 8 to the inside.

In this embodiment, because the inner gate 3 is constituted as a single hinged door (single swinging door) which has the pivotable slanted plate 9, the mechanism for opening-and-closing the inner gate 3 can be simplified.

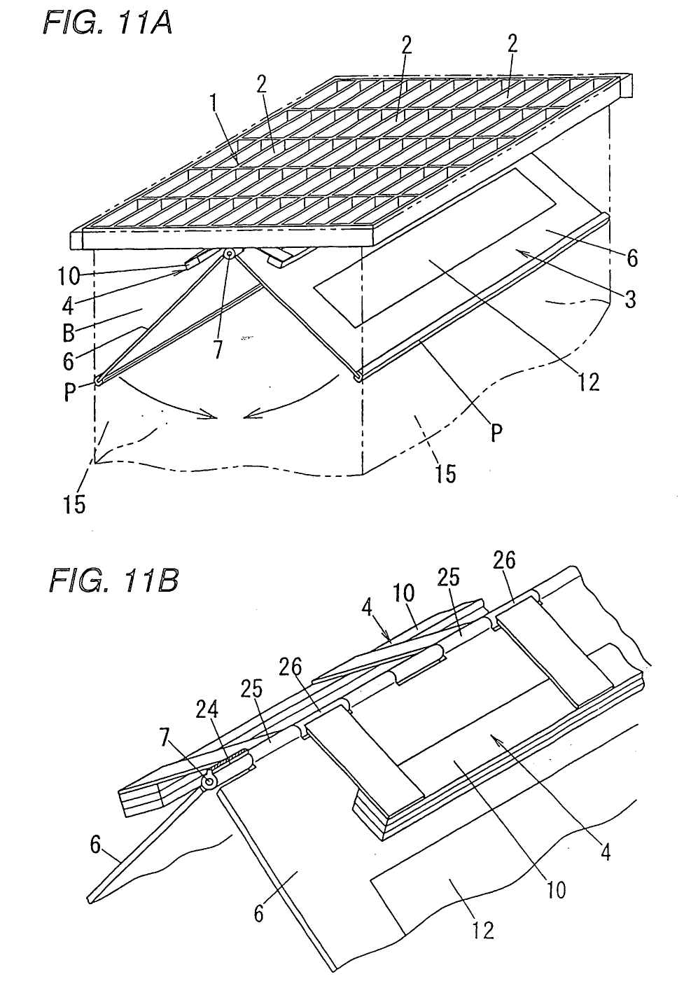

FIGS. 11A and 11B shows a fourth embodiment of the present invention. The basic composition of this embodiment is identical to the above embodiment, so the similar part of these embodiments are identified by the same reference character and no duplicate explanation are made here. In this embodiment, the inner gate 3 is integrated with the basin lid 1. Concretely speaking, bearings 24 are fixed to the basin lid 1 and hold the horizontal pivot axis 7 such as a pin. Bearings 25, 26, which are formed respectively at the upper end of the pair of slanted plates 6, are pivotally supported to the horizontal pivot axis 7, thereby the slanted plates 6 are supported to the basin lid 1 to be pivotable about the horizontal pivot axis 7. In other words, the bearings 24 function as a supporting member whereby the slanted plates 6 are supported to be pivotable around the horizontal pivot axis 7. The balance weights 10 are connected to the slanted plates 6 on the opposite side of the slanted plates 6 over the horizontal pivot axis 7. The balance weights 10 biases each slanted plate 6 in a direction away from each other, so that rainwater will be stemmed between the lower ends of the slanted plates 6 and side walls 15 of the basin body 14 as well as between both side ends in the longitudinal direction of the slanted plates 6 and the side walls 15. Of course, additional side plates may be prepared to block up the both side ends in the longitudinal direction of the slanted plates 6 and form the two inner basin B on both sides under the basin lid 1. In this case, the additional side plates may be integrated with a supporting member fixed to the basin lid 1. Only one slanted plate 6 which crosses the drainage basin A may be provided to form one inner basin B.

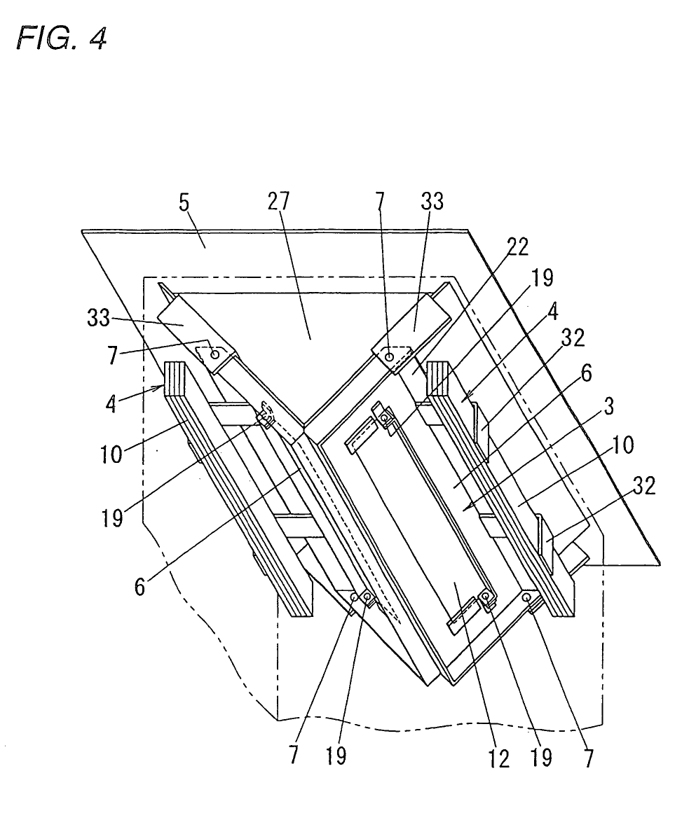

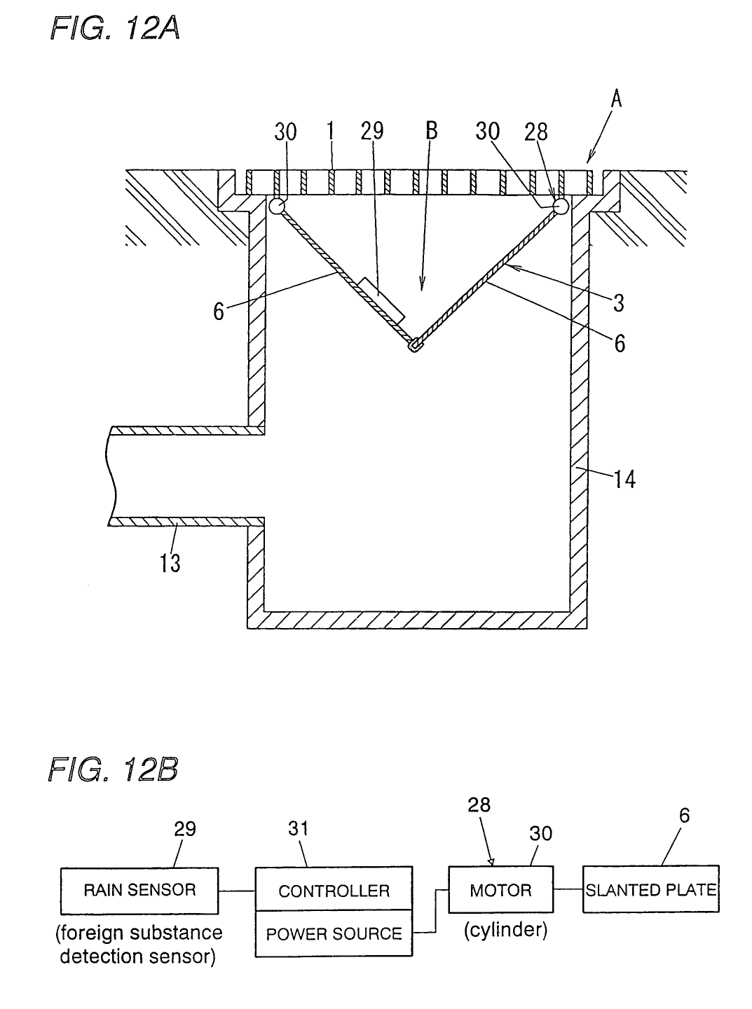

FIG. 12 shows a fifth embodiment of the present invention. The basic composition of this embodiment is identical to the above embodiment, so the similar part of these embodiments are identified by the same reference character and no duplicate explanation are made here. In this embodiment, the inner gate 3 is disposed inside the drainage basin A in the closed position where the inner gate 3 forms the inner basin B under the basin lid 1 to stem rainwater. Also, this embodiment has a means 28, which opens the inner gate 3 of the closed position in response to a sensing result of rainfall. Concretely speaking, each of the slanted plates 6 is pivotally supported by a motor 30 to be pivotable about a horizontal pivot axis, and one slanted plate 6 is provided with a rain sensor 29. A sensing result of the rain sensor 29 is entered into a controller 31, and when amount of rainfall exceeds a predetermined level, a first output signal is outputted from the controller 31. The motor 30 is powered from a power source such as solar battery, and drives the slanted plates 6 in the direction of opening them in response to the first output signal from the controller 31. While the amount of rainfall is below the predetermined level, the controller 31 outputs a second output signal whereby the motor 30 will turn in the reverse direction to pivot the slanted plates 6 and close the inner gate 3. As stated above, in this embodiment, the slanted plates 6 can be opened and closed automatically by electric operation according to amount of rainwater. It is to be understood that, in this embodiment, the horizontal pivot axis 7 may be supported on the basin lid 1 side as the embodiment shown in FIG. 11A, or may be provided on the inner gate 3 side as the embodiment shown in FIG. 4. Also, in addition to the rain sensor 29, a foreign substance detection sensor using photoelectric discharge tube which detects existence of refuse or foreign substances on the inner gate 3 may be provided. In this case, the inner gate 3 may be opened or closed in response to the detection result of the detection sensor. Also, instead of the motor 30, an extendable cylinder may pivot the inner gate 3 around the horizontal pivot axis 7. In a case of controlling drainage in a factory, the motor 30 or the cylinder may be wired with the factory, thereby powered from a power source in the factory. In this case, the inner gate 3 may be opened or closed by remote control using control signal, thereby bad-smelling from a drainage pipe or drain may be prevented from coming into the inside of the factory.

It is to be understood that a construction of the inner gate 3, a supporting construction of the slanted plate 6, 9, and driving composition thereof can be modified without departing from the spirit of the invention.

It goes without saying that the drainage basin A of the present invention may be installed in a market or a factory which deals in, for example, vegetables, flesh fishes or food and has to keep a health standard above a certain level.

1. A drainage basin attachment adapted to be installed in a drainage basin composed of a basin body installed midway through a drainage channel and a basin lid closing a top opening of the basic body, said basin lid having a number of drain holes for passing rainwater therethrough, said attachment comprising:
a supporting member retained to the upper end of said basin body;
an inner gate supported by said supporting member beneath said basin lid to close the top opening of said basin body and form an inner basin for temporarily storing the rainwater passing through the basin lid,
wherein said inner gate is normally closed and is opened by an action of force acting on the inner gate by the rainwater accumulated in the inner basin to an extent above a predetermined level, thereby dropping the rainwater from said inner basic into the basin body.

2. The attachment as set forth in claim 1, wherein
said inner gate comprises:
a pair of slanted plates each pivotally supported at its upper end to said supporting member to be pivotable about a horizontal pivot axis; and
a closing means which biases said slanted plates into a closed position where the slanted plates abut at their lower ends to form the inner basin of a V-shaped section.

3. The attachment as set forth in claim 1, wherein
said inner gate comprises:
a fixed plate fixed to said supporting member and depending therefrom into said basin body;
a slanted plate which extends from said supporting member in an opposed relation to said fixed plate to form therebetween said inner basin, said slanted plate being pivotally supported at its upper end to said supporting member to be pivotable about a horizontal pivot axis; and
a closing means which biases said slanted plate into a closed position where the slanted plate abut at its lower end with the lower end of said fixed plate to close said inner basin.

4. The attachment as set forth in claim 2 or 3, wherein
said closing means comprises a balancer weight connected to said slanted plate on opposite of said horizontal pivot axis from said slanted plate.

5. The attachment as set forth in any one of claims 1 to 4, wherein
said supporting member has a flange which is held between said basin lid and a shoulder formed around said top opening of said basin body to support thereon said basin lid.

6. The attachment as set forth in claim 1, wherein
said inner gate includes a flap valve which permits a reverse water flow from the basin body into the inner basin.

7. A drainage basin attachment adapted to be installed in a drainage basin composed of a basin body installed midway through a drainage channel and a basin lid closing a top opening of the basic body, said basin lid having a number of drain holes for passing rainwater therethrough, said attachment comprising:
a supporting member secured to the upper end of said basin body;
an inner gate supported by said supporting member beneath said basin lid to close the top opening of said basin body and form an inner basin for temporarily storing the rainwater passing through the basin lid,
a rain sensor providing an output when sensing a critical amount of rainfall; and
means for opening said inner gate to drop the water from said inner basin into the basin body in response to said output.

8. A drainage basin adapted to be installed midway through a drainage channel for collecting and flowing rainwater flowing into the drainage channel, said drainage basin comprising
a basin body with a top opening;
a basin lid covering the top opening of the basin body and having a number of drain holes for passing the rainwater therethrough;
an inner gate mounted beneath the basin lid to close the top opening of the basin body, said inner gate forming an inner basin for temporarily storing the rainwater passing through the basin lid,
wherein said inner gate is normally closed and is opened by an action of force acting on the inner gate by the rainwater accumulated in the inner basin to an extent above a predetermined level, thereby dropping the rainwater from said inner basic into the basin body.
